(19) United States
(12) Patent Application Publication
(10) Pub. No.: US 2014/0112365 A1
(43) Pub. Date: Apr. 24, 2014

(54) METHOD FOR OPERATING ALTERNATING-CURRENT ELECTRIC ARC FURNACE, DEVICE FOR PERFORMING METHOD, AND ALTERNATING-CURRENT ELECTRIC ARC FURNACE HAVING SUCH DEVICE

(71) Applicants: Thomas Matschullat, Eckental (DE); Detlef Rieger, Baldham (DE)

(72) Inventors: Thomas Matschullat, Eckental (DE); Detlef Rieger, Baldham (DE)

(73) Assignee: SIEMENS AKTIENGESELLSCHAFT, München (DE)

(21) Appl. No.: 14/111,419

(22) PCT Filed: Mar. 20, 2012
(86) PCT No.: PCT/EP2012/054863

§ 371 Date: Dec. 20, 2013

(30) Foreign Application Priority Data
Apr. 13, 2011 (EP) 11162238.7

(51) Int. Cl. F27B 3/28; F27D 19/00; F27D 11/10

(52) U.S. Cl. CPC F27B 3/28; F27D 11/10; F27D 19/00
USPC 373/105

(57) ABSTRACT

During operation of an alternating-current electric arc furnace, which has at least one electrode for producing a melt, vibrations are measured at a wall of a furnace vessel, whereby a slag height of the melt is determined. A rapid reaction to the change in the slag height is made possible by adjusting the arc length of the at least one electrode in the case of deviations of a measured actual value of the slag height from a target value.

### CROSS REFERENCE TO RELATED APPLICATIONS

This application is the U.S. national stage of International Application No. PCT/EP2012/054863, filed Mar. 20, 2012 and claims the benefit thereof. The International Application claims the benefit of European Application No. 11162238 filed on Apr. 13, 2011, both applications are incorporated by reference herein in their entirety.

### BACKGROUND

Described below is a method for operating an alternating-current electric arc furnace having at least one electrode for producing a melt in a furnace vessel, wherein vibrations are measured at a wall of the furnace vessel, whereby a slag height of the melt is determined. Also described are a device for performing the method and an alternating-current electric arc furnace having such a device.

When steel is produced in an electric arc furnace, in particular in an alternating-current electric arc furnace, a foamed slag or slag is formed and caused to foam by injecting a mixture of media, for example a mixture of pulverized coal and oxygen, in order to improve the energy input by an arc produced by the electrodes of the electric arc furnace or to reduce the losses due to radiation. The state of the foamed slag of the melt is a measure of the effectiveness of the energy input. The objective therefore is to achieve a level of foamed slag in the interior of the furnace which is adjusted as far as possible to the process requirements.

It is known from WO 2007/009924 to determine the energy supply into an electric arc furnace with the aid of electrical sensors and to measure vibrations at the electric arc furnace. The height of the foamed slag is ascertained by evaluating the measurement data from the electrical sensors and by evaluating the measured vibrations.

It is furthermore known from WO 2010/088972 to ascertain the height of the foamed slag in order to regulate a carbon monoxide emission from an electric arc furnace, in which case the carbon input and/or the oxygen supply are regulated in such a manner that the height of the foamed slag is held below a maximum value.

The regulation of the carbon input does however have the disadvantage that if no constant and uniform slag height level is achieved for all regions of the electric arc furnace within a short time, due to a delay in the coal delivery, excessive radiated power will be output to the walls. In this situation, hot spots are produced at the furnace walls which result in energy losses and increase wear.

### SUMMARY

The method enables a rapid reaction to the change in the slag height in the alternating-current electric arc furnace.

This method for operating an alternating-current electric arc furnace, having at least one electrode for producing a melt in a furnace vessel, measures vibrations at a wall of the furnace vessel, by which a slag height of the melt is determined and in the case of deviations of a measured actual value of the slag height from a target value, issues control and/or regulating signals which serve to adjust an arc length of the at least one electrode.

The device includes
at least one structure-borne sound sensor for the acquisition of vibrations at a wall of a furnace vessel of an alternating-current electric arc furnace, wherein the alternating-current electric arc furnace has at least one electrode for producing a melt in the furnace vessel,
a processing unit for calculating the actual value of the slag height in the furnace vessel, and
a control or regulating unit for adjusting the arc length of the at least one electrode in the case of deviations of the actual value of the slag height from the target value.

Also described below is an alternating-current electric arc furnace having such a device.

The advantages and embodiments stated below in relation to the method can be applied by analogy to the device and the alternating-current electric arc furnace.

Target value does not in this case in particular denote an absolute value but a permissible range which is characterized by a permissible maximum value and a permissible minimum value. In the event of the target range being exceeded or undershot, the permissible maximum value is thus exceeded or the permissible minimum value undershot.

The method is based on the idea of influencing the length of the arcs produced in the alternating-current electric arc furnace as a reaction to the change in the height of the slag in the furnace vessel. This is achieved by an appropriate regulation of the at least one electrode of the alternating-current electric arc furnace, in particular by regulating the impedance of the electrode. In this situation it is the case that an increase in the impedance results in an extension of the arc length and thus in an increase in the radiated power. A lower impedance on the other hand results in a reduction in the arc length and thus in the radiated power, but the thermal convection of the arc is increased in this situation.

Normally in the case of deviations in the measured height of the foamed slag from the predefined target value the coal supply is increased or reduced for a certain time, as is revealed in WO 2010/088972. In consequence of the conveyor delay there will be a time lag before the reaction to this action which is in the order of approx. 20 seconds. In comparison therewith, the electrode regulation for the adjustment of the arc length takes place with a significantly shorter reaction time of approx. one second. Thanks to the regulation of the arc length, lower radiation losses occur which result in a minimized radiation to the furnace walls. A uniform and rapid melting of the solid material or scrap metal charge of the alternating-current electric arc furnace is moreover achieved as a result of the targeted, demand-oriented performance optimization of the electrodes. A further advantage of the optimized regulation of the arc length is a reduction in the pulverized carbon, which means that a lower level of CO₂ emissions is achieved through lower energy and carbon consumption. The method is thus characterized by greater productivity, lower energy losses, reduced period of operation and by a reduction in wall wear.

The measurement of the height of the slag is based on the methods described in WO 2007/009924 and WO 2010/088972. The processing unit which determines the slag height in the furnace vessel on the basis of the measurement signals from the at least one structure-borne sound sensor is in particular part of the control and/or regulation unit which for the sake of simplicity is referred to below as regulation unit. After the actual value of the slag height has been calculated, the actual value is compared with the target value or target range. In the case of deviations, the regulation unit generates the control and/or regulation signals for adjustment of the arc length.

In order to ensure highly dynamic and targeted control or regulation of the arc length the melting process is subdivided into at least two, in particular into three periods of development of the slag and the arc length of the at least one electrode is regulated depending on the development period. In this case it is necessary to differentiate in particular between the following three development periods: a slag build-up or start period, in which the slag is produced; a slag period, in which the height of the slag reaches a maximum level; and an end period, in which the height of the slag drops back again. The reaction to the change in slag state thus takes place having regard to the time which has elapsed since the commencement of the melting process in the alternating-current electric arc furnace because the time is crucial to the development of the slag.

If a very low slag state is measured in the start period, this indicates an incomplete melting of the scrap metal. In this case the optimum regulation of the arc length depends on which region of the furnace vessel scrap metal having the greater size and shape value is located in. A value for the size and shape of a solid material is understood to be any concrete variable which is suitable for demonstrating differences in the size and shape of differently fragmented solid material. Size and shape of the solid material can be understood to be any physical variable of the solid material which influences the burning behavior of the arc on the solid material. In particular, the variable of a contiguous solid material component and/or the compactness thereof can be understood thereby, in which case compactness is to be understood in the meaning of a measure of an existing solid material density distribution. A method for ascertaining the size and shape value for solid material in an arc furnace is described in WO 2009/095293 A2.

If solid material having a large size and shape value is located beneath the at least one electrode in a start period, then when the target value is undershot the arc length of the at least one electrode may be reduced, as a result of which an increase in convection energy is achieved in the vicinity of or below the electrode.

However, if solid material having a large size and shape value is located further away from the electrode in the vicinity of the wall, then when the target value is undershot the arc length of the at least one electrode is advantageously increased. As a result the radiated power is increased and that promotes the melting of the scrap metal in the vicinity of the wall.

If an increase in the radiated power and thus in the radiation to the furnace wall is not regarded as acceptable, according to an alternative embodiment if the target value is undershot in the start period the arc length of the at least one electrode remains unchanged and the period of operation of the energy supply is extended.

In accordance with a variant embodiment, if the target value is undershot the arc length of the at least one electrode is reduced both in the slag period and also in the end period of the slag development. In order to avoid wear at the furnace walls, the radiated power delivered to the furnace wall is reduced in this case.

The target value being exceeded is in particular handled in the same manner in all development periods of the slag. If the actual value exceeds the target value, the arc length of the at least one electrode may be increased.

The adjustment of the arc length takes place in particular in addition to a regulation of the carbon or oxygen injection as a reaction to the change in the slag height. Against this background, in the case of deviations of the slag height from the target value the carbon supply into the alternating-current electric arc furnace is likewise advantageously regulated. If for example the slag height is above the target value or target range, the injection of coal is reduced. Since the reaction time to this operation is several seconds, the arc length of the electrode is adjusted in parallel thereto. Conversely, if the target value for the slag height is undershot the carbon supply is increased and the arc length is likewise adjusted at the same time. Similarly, in the case of deviations of the slag height from the target value the oxygen supply into the alternating-current electric arc furnace is expediently controlled or regulated in corresponding fashion.

The vibrations of the alternating-current electric arc furnace may be measured with the aid of at least one structure-borne sound sensor, in particular an acceleration sensor. The structure-borne sound of the arc is conducted through the melt and/or through the foamed slag to the furnace vessel and can be measured there in the form of vibrations. In this situation the structure-borne sound sensors are in particular connected indirectly and/or directly to the furnace vessel or to the wall of the furnace vessel. The structure-borne sound sensors are arranged for example evenly spaced around the furnace vessel. In order to increase the accuracy of the structure-borne sound measurements, one structure-borne sound sensor is in particular provided per electrode.

The alternating-current electric arc furnace expediently has three electrodes and one structure-borne sound sensor is provided for each. In this situation, one zone of the furnace vessel is associated with each electrode and the height of the slag is determined for each zone. The control or regulation of each of the three electrodes takes place in this case in particular independently of that of the other two electrodes. The foamed slag height is measured separately in all three zones of the furnace vessel and the arc length of each of the three electrodes is adjusted individually to the spatial slag height distribution in the furnace vessel on the basis of the measurement data from the corresponding zone.

For example, at least one fuzzy controller may be used for regulation of the electrode. Fuzzy controllers are systems belonging to the class of characteristic map controllers which conform to the theory of fuzzy logic. In each regulation step, three substeps are performed: a fuzzification, an inference and finally a defuzzification. The individual inputs and outputs are referred to as linguistic variables, to which belong fuzzy sets in each case. Such a fuzzy controller can in this case for example have recourse to a reaction model stored in the processing unit.

### BRIEF DESCRIPTION OF THE DRAWINGS

These and other aspects and advantages will become more apparent and more readily appreciated from the following description of the exemplary embodiment, taken in conjunction with the accompanying drawings of which:

FIG. 1 is a schematic perspective view of an alternating-current electric arc furnace, and

FIG. 2 is a graph of the time characteristic of the slag height in an alternating-current electric arc furnace.

### DETAILED DESCRIPTION OF THE PREFERRED EMBODIMENT

Reference will now be made in detail to the preferred embodiments, examples of which are illustrated in the accompanying drawings, wherein the same reference characters have the same meaning in the different figures.

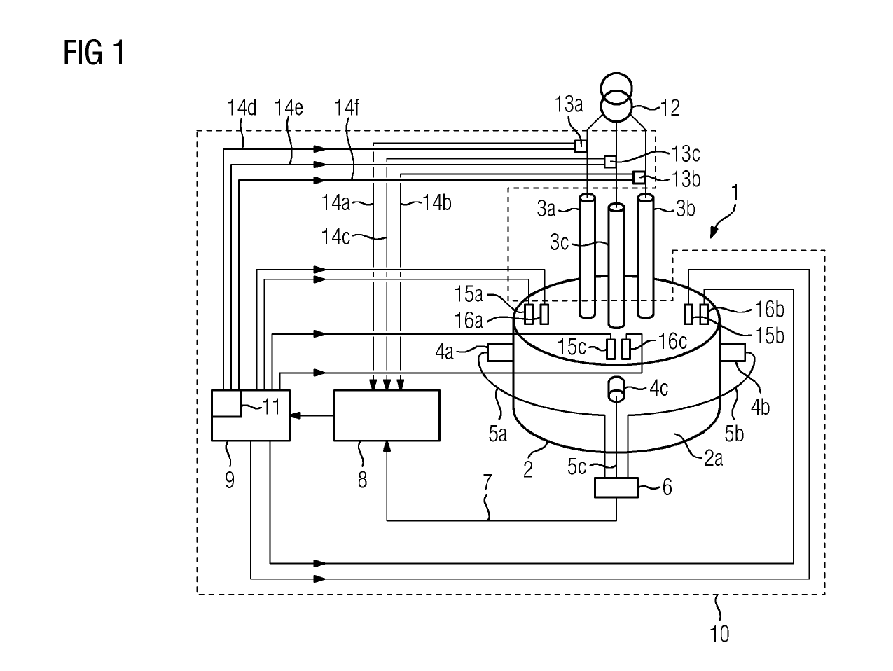

FIG. 1 shows an alternating-current electric arc furnace 1 having a furnace vessel 2 into which is introduced a plurality of electrodes 3a, 3b, 3c which are coupled with a power supply facility 12 by way of power supply lines. The power supply facility 12 may include a furnace transformer. With the aid of three electrodes 3a, 3b, 3c charge materials such as for example scrap metal are melted in the alternating-current electric arc furnace 1. When producing steel in the alternating-current electric arc furnace 1 a slag or foamed slag (not shown here in detail) is formed.

At a wall 2a of the furnace vessel 2, in other words at the outer perimeter of the furnace vessel 2, are arranged structure-borne sound sensors 4a, 4b, 4c for the measurement of vibrations. The structure-borne sound sensors 4a, 4b, 4c can be connected indirectly and/or directly to the furnace vessel 2. The structure-borne sound sensors 4a, 4b, 4c are in particular arranged at sides of the wall 2a opposite the electrodes 3a, 3b, 3c. The structure-borne sound sensors 4a, 4b, 4c may in this case be designed as acceleration sensors and are positioned above the foamed slag in the furnace vessel 2. One electrode 3a, 3b, 3c is associated with each structure-borne sound sensor 4a, 4b, 4c, thereby enabling spatially resolved information to be obtained concerning the slag height in three zones of the furnace vessel 2 which are formed around each of the electrodes 3a, 3b, 3c.

The measurement values or signals from the structure-borne sound sensors 4a, 4b, 4c are fed by way of protected lines 5a, 5b, 5c into an optical facility 6 and routed by the latter by way of an optical wave guide 7 in the direction of a processing unit 8. The signal lines 5a, 5b, 5c may be routed so as to be protected against heat, electromagnetic fields, mechanical stress and/or other stress factors.

In the exemplary embodiment shown according to FIG. 1, on the power supply lines for the electrodes 3a, 3b, 3c are provided sensor and regulation facilities 13a, 13b, 13c by which current and/or voltage or the energy supplied to the electrodes 3a, 3b, 3c can be measured and regulated. The sensor and regulation facilities 13a, 13b, 13c are coupled with a regulation unit 8 for example by way of signal lines 14a, 14b, 14c designed as cables. Further signal lines 14d, 14e, 14f serve to connect the sensor and regulation facilities 13a, 13b, 13c to a control or regulation facility 9 which receives the regulating stipulations from the processing unit 8. The control and/or regulation facility 9 is referred to simply as regulation facility 9 in the following. As an alternative to the exemplary embodiment according to FIG. 1 the regulation unit 8 can be an integral part of the control and/or regulation facility 9.

The structure-borne sound sensors 4a, 4b, 4c, the sensor and regulation facilities 13a, 13b, 13c, the processing unit 8 and also the regulation facility 9 are part of a device 10 which is indicated in FIG. 1 by dashed lines.

Carbon injection devices 15a, 15b, 15c and also oxygen injection devices 16a, 16b, 16c are furthermore associated with the alternating-current electric arc furnace 1.

In the processing unit 8 the measurement values or signals from the structure-borne sound sensors 4a, 4b, 4c and the sensor and regulation facilities 13a, 13b, 13c are acquired and evaluated in order to determine the height of the foamed slag in the furnace vessel 2. The measurement values or signals determined by the structure-borne sound sensors 4a, 4b, 4c are correlated with the height of the slag, where a temporal resolution in the region of approx. one to two seconds is possible. The processing unit 8 forwards to the regulation facility 9 at least one regulating signal or one regulating stipulation, based on the currently calculated height of the foamed slag per zone in the furnace vessel 2 or averaged over the zones.

According to stipulations of the processing unit 8 the regulation facility 9 regulates both the supply of carbon and oxygen and also the arc lengths of the electrodes 3a, 3b, 3c by way of the impedance of the electrodes 3a, 3b, 3c. Crucial to the regulation is a temporal differentiation between the different development periods of the foamed slag, such that the arc is regulated differently depending on the different stages of slag formation. The regulation facility 9 may include a fuzzy controller 11.

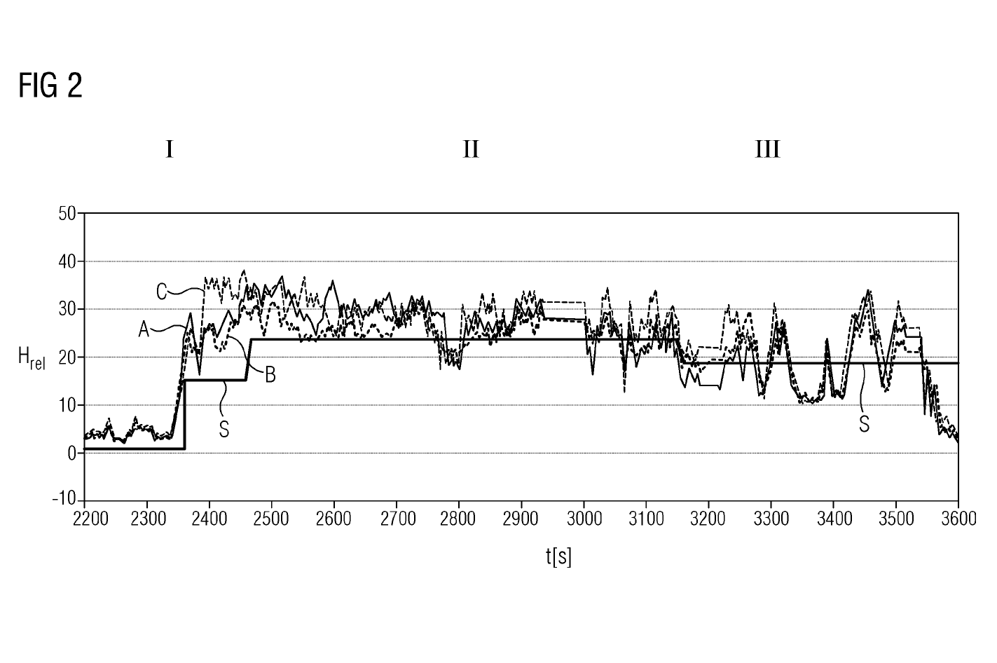

The course of action during the regulation of the arc of the electrodes 3a, 3b and 3c is explained with reference to the diagram in FIG. 2 in which the relative slag height Hᵣₑₗ is plotted over the time t. The X axis represents the time in seconds at the commencement of the melting process in the alternating-current electric arc furnace 1. The measurement signal from the three structure-borne sound sensors 4a, 4b, 4c, in other words the characteristics of the slag height determined for the three zones in the furnace vessel 2, is given by three oscillating lines A, B, C. In this situation, essentially three different stages are to be recognized in the development of the slag. A start or slag build-up period I in which the slag height rises has a duration according to FIG. 2 of up to approx. 2450 seconds after the commencement of the melting process. This is followed by a slag period in which the slag height averaged over time remains essentially constant. As of approx. 3150 seconds after the commencement of the melting process in the alternating-current electric arc furnace 1 an end period of slag formation commences in which the fluctuations of the slag height Hᵣₑₗ are particularly strong and the averaged relative slag height is a little lower than in the slag period.

The reference character S in FIG. 2 identifies a target value for the relative slag height Hᵣₑₗ. The target value S is different in the three development periods of the slag. The target value S can alternatively represent a target range between a permissible minimum value and a permissible maximum value.

Heavy foaming can occur in the start period I, but in the individual zones which are not heated sufficiently the foaming can be greatly delayed. Four cases are therefore to be differentiated with respect to the start period I:

1) In one zone, such as for example that of measurement value C, the slag level is excessively high, while in the other two zones the slag level is normal. In this case the arc at the electrode 3c is lengthened.
2) If an excessive slag state is measured in all three zones, the arc of all three electrodes 3a, 3b, 3c is lengthened, which results in increased radiated power.
3) If the slag height is too low, the regulation of the arc length takes place depending on whether the larger chunks of scrap metal are located in the vicinity of the electrodes or of the wall of the alternating-current electric arc furnace. If they are below the electrode, the arc is shortened; if they are closer to the wall, the arc is lengthened.
4) If the slag height is too low in all the zones A, B, C, this means that the melt requires longer to heat up and no change is therefore made in respect of the arc length.

In the slag period II and also in the end period III the same four cases are to be differentiated, however they do in part require a different course of action:

1) If the slag state is significantly higher in at least one zone than in the other zones, this is handled as in case 1 in respect of the start period I.
2) If all three zones exhibit an excessive slag level, this is handled as in case 2 in respect of the start period I.
3) If the target value requirement S is undershot in at least one zone, then the arc length of the corresponding electrode 3a, 3b, 3c associated with the zone is reduced. The radiated power is thereby correspondingly corrected downwards in order to treat the wall 2a with care during operation.
4) And finally, if all the actual measurement values A, B, C, for the slag height Hᵣₑₗ in all the zones of the alternating-current electric arc furnace 1 drop below the target value S, the arc lengths at all three electrodes 3a, 3b, 3c are reduced and the radiated power is thus reduced up until the interim reaction of the slag to the introduced carbon.

The fuzzy-based control system outputs the correction factors for the individual arc lengths, which are processed and set in an electrode regulation process. The main advantage of regulating the arc length is the short reaction time of approx. one second. It is thus possible to react particularly quickly to the conditions prevailing in the furnace vessel 2. The adjustment of the arc length is performed in particular in combination with a regulation of the carbon or oxygen supply and serves to optimize the power delivery and thus to reduce radiation losses to the wall of the alternating-current electric arc furnace.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-17. (canceled)

18. A method for operating an alternating-current electric arc furnace having at least one electrode for producing a melt in a furnace vessel, comprising:
measuring vibrations at a wall of the furnace vessel;
determining a slag height of the melt based on the vibrations measured; and
issuing, when a measured actual value of the slag height deviates from a target value, at least one of control signals and regulating signals to adjust an arc length of the at least one electrode.

19. The method as claimed in claim 18,
wherein said method is applied to at least two periods of development of the slag, and
wherein the arc length of the at least one electrode is regulated depending on a development period.

20. The method as claimed in claim 19, wherein said method is applied to three periods of development of the slag.

21. The method as claimed in claim 20, wherein if the target value is undershot in a start period of the slag, development the arc length of the at least one electrode is reduced if solid material having a large size and shape value is located beneath the at least one electrode.

22. The method as claimed in claim 20, wherein if the target value is undershot in a start period of the slag, development the arc length of the at least one electrode is increased if solid material having a large size and shape value is located in a vicinity of the wall.

23. The method as claimed in claim 20, wherein if the target value is undershot in a start period of the slag, development the arc length of the at least one electrode remains unchanged and the period of operation of the at least one electrode is extended.

24. The method as claimed in claim 20, wherein if the target value is undershot in a slag period and in an end period of the slag, development the arc length of the at least one electrode is reduced.

25. The method as claimed in claim 20, wherein if the target value is exceeded, the arc length of the at least one electrode is increased.

26. The method as claimed in claim 20, further comprising regulating a carbon supply into the alternating-current electric arc furnace, if the slag height deviates from the target value.

27. The method as claimed in claim 20, further comprising regulating an oxygen supply into the alternating-current electric arc furnace, if the slag height deviates from the target value.

28. The method as claimed in claim 20, wherein said measuring measures the vibrations of the alternating-current electric arc furnace using at least one structure-borne sound sensor, in particular an acceleration sensor.

29. The method as claimed in claim 20, wherein said measuring measures the vibrations of the alternating-current electric arc furnace using an acceleration sensor.

30. The method as claimed in claim 20, wherein the alternating-current electric arc furnace has three electrodes, and
wherein said determining detects the height of foamed slag in a zone of the furnace vessel associated with each of the three electrodes.

31. The method as claimed in claim 20, wherein a fuzzy controller is used for regulation of the arc length of the at least one electrode.

32. A device for controlling operation of an alternating-current electric arc furnace having at least one electrode for producing a melt in a furnace vessel, comprising:
at least one structure-borne sound sensor configured to acquire vibrations at a wall of the furnace vessel;
a processing unit configured to calculate an actual value of a slag height in the furnace vessel; and
a control or regulating unit configured to adjust an arc length of the at least one electrode in the case of deviation of the actual value of the slag height from a target value.

33. The device as claimed in claim 31, wherein the structure-borne sound sensor is an acceleration sensor.

34. The device as claimed in claim 32, wherein the control or regulating unit includes a fuzzy controller.

35. An alternating-current electric arc furnace, comprising:
a furnace vessel having a wall;
at least one electrode configured to produce a melt in the furnace vessel; and
a control device, including
at least one structure-borne sound sensor configured to acquire vibrations at the wall of the furnace vessel;
a processing unit configured to calculate an actual value of a slag height in the furnace vessel; and
a control or regulating unit configured to adjust an arc length of the at least one electrode in the case of deviation of the actual value of the slag height from a target value.

36. The alternating-current electric arc furnace as claimed in claim 33,
wherein the at least one electrode is three electrodes, and
wherein the at least one structure-borne sound sensor includes three structure-borne sound sensors, respectively provided for the three electrodes.
